(19) United States
(12) Patent Application Publication
(10) Pub. No.: US 2015/0014898 A1
(43) Pub. Date: Jan. 15, 2015

(54) DEVICE AND METHOD FOR PRODUCING A MOULDED PART FROM A COMPOSITE MATERIAL

(71) Applicant: TECHNI-MODUL ENGINEERING, Coudes (FR)

(72) Inventor: Serge Luquain, Saint Germain Lembron (FR)

(21) Appl. No.: 14/375,829

(22) PCT Filed: Jan. 30, 2013
(86) PCT No.: PCT/FR2013/050183

§ 371 Date: Jul. 31, 2014

(30) Foreign Application Priority Data
Jan. 31, 2012 (FR) 12/50874

(51) Int. Cl. B29C 70/48; B29C 33/00; B29C 70/54

(52) U.S. Cl. CPC B29C 70/48; B29C 70/545; B29C 70/54; B29C 33/0055; B29K 2101/10
USPC 264/571; 425/546

(57) ABSTRACT

The invention concerns a device (1) for producing a moulded part from a composite material comprising a mixture of reinforcement fibres (2) and a resin (3), said device (1) comprising: a mould (4) wherein a recess (5) is provided, configured for the arrangement of the fibres (2); a counter-mould (6) which is provided with at least one channel (9) for introducing the resin (3) into the recess (5), and which is intended to rest against the mould (4) in order to close the recess (5); means for positioning and securing the counter-mould (6) on the mould (4); at least one means (7) for depressurising the recess (5) the mould (4) and the counter-mould (6) comprising respective support areas surrounding the recess (5), which comprise two seals delimiting a dosing chamber (22). The invention also concerns a method for producing a moulded part from a composite material implementing the device (1).

### TECHNICAL FIELD

The invention relates to a device, as well as a process for manufacturing a molded part from a composite material.

### BACKGROUND

In the context of the present invention, it is meant by composite material, a material comprising a resin (thermoplastic or thermosetting) and reinforcing fibers (for example glass fibers). The resin constitutes the matrix of the composite material. The matrix ensures the cohesion and the orientation of the reinforcing fibers. In addition, the matrix allows the transmission of mechanical stresses to which the molded part is subjected. The reinforcing fibers contribute to improving the mechanical resistance and the stiffness of the molded part.

Parts molded from a composite material are shaped for a wide variety of applications, such as the manufacture of cases, boat hulls, bicycle frames, vehicle body elements, tanks, various sanitary articles, or even more generally, any industrial parts with very varied and more or less complex shapes.

Several technologies are known for manufacturing molded parts from a composite material, among which mention may be made of:
the injection molding (more commonly called “RTM”: Resin Transfer Molding), and
the infusion.

The RTM technique allows manufacturing molded parts of small or big size. The injection molding is carried out with rigid mold and counter-mold. The reinforcing fibers are disposed in a cavity with which the mold is provided. The counter-mold is fixed on the mold thanks to a closing pressure obtained by means of a press or an autoclave. Then, the resin is injected by means of a low pressure pump (about 1 to 5 bars) through the reinforcing fibers until the complete filling of the cavity. After the curing of the resin, the mold is open and the part is demolded.

The advantages of the RTM technique are the following:
a constant quality of the molded parts;
a high production rate;
molded parts of great dimension (up to about 7 m²);
automation of the manufacturing process.

However, the RTM technique has the following drawbacks:
the molded parts have slightly or averagely complex shapes;
it is necessary to make finishes after demolding;
a good reproducibility of the manufacture of the molded part;

The infusion technique for the manufacture of a molded part from a composite material consists of vacuumizing, in a mold covered with a superimposition of tissues and consumables which constitute a drape molding and of which the last thickness is a vacuum bag, dry reinforcing fibers, then impregnating them by the injection and the migration of a resin within these reinforcing fibers due to the maintaining of vacuum. The resin is then sucked by the depression created between the vacuum bag and the mold and thus penetrates in the reinforcing fibers. Then, the vacuum is maintained during the resin polymerization, in order to guarantee the pressurizing of the reinforcing fibers. The vacuumization carried out before the resin injection allows compacting the reinforcing fibers and ensuring that there is no air leakage. Once the thermosetting of the resin is done, the drape molding is removed and the molded part is then removed from the mold.

The drape molding is generally constituted of the following elements: peeling tissue and demolding tissue, diffusion grid, diffusion tube, draining tissue, vacuum bag and mastic, in order to ensure an optimal impregnation of the resin within the reinforcing fibers.

The infusion is particularly based on the physical principle of the reinforcing fibers permeability.

The reinforcing fibers permeability consists of:
the macroscopic permeability (space between the fibers);
the microscopic permeability (or capillarity).

The macroscopic permeability varies with the reinforcing fibers compression. The microscopic permeability depends on the surface tension of the impregnation resin. The stronger the surface tension, the more reduced the fibers impregnation by capillarity.

The viscosity of the impregnation resin is also an important parameter of the infusion: The lower the viscosity of the resin, the quicker the infusion.

The advantages of the infusion technique are the following:
a good reproducibility of the manufacture of the molded part;
a carrying out of big-sized and complex-shaped parts in one single step
an optimal and controlled reinforcement volume rate, in the range of 50 to 60% in volume, thus the parts obtained by infusion exhibit very good mechanical properties;

However, the difficulties and drawbacks of the infusion technique are the following:
the need for non-reusable materials which are constituted of the tissues and consumables of the drape molding, as well as their meticulous and non-automated laying. That implies materials and labor costs which are consequent and which depend on the dimensions of the molded parts;
a low production rate, due to the meticulous operations of laying the drape molding;
a limited thickness of the molded part, because the thickness must be low enough so that the resin correctly penetrates in all the volume occupied by the reinforcing fibers, only by vacuum suction;
the vacuum control. Indeed, the vacuum for pressurizing the reinforcing fibers may be disturbed by the resin which has been infused. It is essential that the reinforcing fibers remain under pressure until the end of the polymerization in order not to impair the mechanical properties and the geometry of the molded part that is desired to obtain. Yet, the resin may obstruct the drawing point of the vacuum;
the need for the polymerization temperature homogeneity over the entire molded part; objective which is all the more difficult to achieve since the face of the molded part in contact with the drape molding is subjected to the ambient air temperature;
the face of the molded part which has been in contact with the drape molding does not have a smooth and defect-free surface, because the drape molding is constituted of flexible elements which do not allow obtaining a homogenous surface.

Thus, the infusion technique allows obtaining a molded part having one single external face which is smooth and free of surface defects.

### BRIEF SUMMARY

The present invention proposes to overcome the drawbacks inherent to the manufacture of a molded part from a composite material with known techniques which are particularly the RTM and the infusion and which have been detailed above.

Indeed, the present invention provides a device for manufacturing a molded part from a composite material, designed so as to get free from non-reusable and furthermore onerous materials, such as tissues and consumables, during the manufacture of the molded part, as it is the case for the infusion technique, and that while guaranteeing mechanical properties of the molded part as good as those obtained with the infusion technique.

The device according to the invention is also designed to further have the advantage, relative to the RTM technique, of not requiring means for closing the counter-mold on the press or autoclave type mold which are means that increase the manufacturing cost of a molded part from a composite material.

The present invention also provides a process for manufacturing a molded part from a composite material implementing said device.

The device for manufacturing a molded part from a composite material, comprising a mixture of reinforcing fibers and a resin according to the invention, comprises:
one mold in which a cavity configured for the disposition of the reinforcing fibers is arranged;
one counter-mold which, intended to press against the mold to close the cavity, is equipped with at least one channel for introducing the resin in the cavity, said introduction channel being adapted to be connected to at least one resin supply source;
means for positioning and fixing the counter-mold on the mold;
at least one means for depressurizing the cavity to ensure the introduction of resin therein and at least one channel for extracting the resin in excess out of the cavity,

and is characterized in that the mold and the counter-mold include respective support areas surrounding the cavity, these support areas comprising two peripheral seals offset with respect to each other, from the inside to the outside, delimiting a closing chamber which is connected to a vacuum source, said vacuum source depressurizing the closing chamber to ensure the plating of the counter-mold on the mold.

Advantageously, the closing chamber is dimensioned in accordance with the size of the part to be molded, the pressure that is desired to be applied on the fibers and the injection pressure.

With the closing chamber that the device according to the invention comprises, the pressure on the reinforcing fibers disposed in the cavity may be in the range of 0.25 MPa before injection of the resin: that corresponds to the cumulative force brought by the closing chamber which may rise up to about 0.15 MPa and by that of the cavity. And once the resin is injected in the cavity, only the force of the closing chamber persists.
Thus, the closing chamber allows getting free from means for closing the counter-mold on the press or autoclave type mold which are means that have the following drawbacks:
they increase the manufacturing cost of a molded part from a composite material, due to their high cost;
they are not easy to manipulate and require a lot of handling steps;
they risk damaging the mold and the counter-mold during their utilization for manufacturing the molded part, and furthermore when they are not correctly parameterized;
they are bulky;
they require an important investment.

With a closing chamber that the device according to the invention comprises, once the counter-mold is put in place on the mold, it is enough to vacuumize the closing chamber: which is simple and quick in implementation, and this without the risk of damaging the mold and the counter-mold.

We thus easily understand all the advantages of the device according to the invention which comprises in an innovative manner a closing chamber substituting a closing means of the counter-mold on the press or autoclave type mold.

The resin may be a thermosetting resin or a thermoplastic resin. Preferably, it is a thermosetting resin.

In the context of the present invention, it is meant by cavity depressurizing means, a means adapted to establish within the mold cavity a residual vacuum of at least 200 mbar, which corresponds to a depression of about 800 mbar. Preferably, the residual vacuum prevailing in the cavity is of at least 50 mbar, corresponding to a depressurization of about 950 mbar.

When the cavity is depressurized, the resin originating from the supply source which may advantageously comprises dosing pumps system, is introduced in the cavity via the introduction channel. The resin then impregnates the reinforcing fibers which have been disposed in the cavity and is sucked via the extraction channel due to the depressurization of the cavity. Resin is introduced in the cavity until an excess of resin comes out via the extraction channel: at this stage, all the reinforcing fibers have been impregnated with resin, due to physical phenomena which are the macroscopic and microscopic permeability of these reinforcing fibers which have been detailed above for the infusion.

Preferably, the cavity depressurizing means comprises a vacuum pump, a channel arranged in the counter-mold or in the mold used for depressurizing the cavity and extracting the resin in excess out of the cavity, and a depressurizing circuit in the form of a pipe which connects the vacuum pump to the channel.

Advantageously, the pipe connecting the channel arranged in the counter-mold or in the mold to the vacuum pump is equipped with a seal pot intended to collect the resin that is extracted from the cavity. The seal pot thus allows avoiding that resin submerge the vacuum pump.

According to one embodiment of the invention, the introduction channel and the extraction channel have a truncated cone shape. That provides the advantage of being able to easily remove, from the counter-mold by “demolding”, the resin remaining stored in these channels at the end of the molded part manufacturing and which will also have polymerized. Thus, after removal of this small quantity of resin remaining in these channels arranged in the counter-mold, the device is once again ready for the molding of another part from a composite material.

According to one advantageous embodiment of the invention, the closing chamber is connected to the vacuum source by means of a vacuumizing circuit in the form of a pipe and a channel arranged in the counter-mold or in the mold.

Preferably, the vacuum source is a vacuum pump. This vacuum, also called “closing vacuum”, may be obtained with the same vacuum pump as that utilized for the depressurization of the cavity. This is why, advantageously, the cavity depressurizing circuit and the closing chamber vacuumizing circuit are disposed in parallel and converge upstream of the same vacuum pump.

Furthermore, the cavity depressurizing circuit and the closing chamber vacuumizing circuit may be equipped with means for measuring and means for regulating the pressure and the flow rate.

Advantageously, the closing vacuum is of at least 300 mbar, which corresponds to a depression of about 700 mbar. Preferably, it is of at least 200 mbar (corresponding to a depression of 800 mbar).

The mold and the counter-mold may be made of a composite material, a metallic material or any other material adequate for manufacturing a mold which is available to those skilled in the art.

According to a very advantageous embodiment of the device according to the invention, it further comprises at least one means for centering the counter-mold on the mold.
The cavity may comprise an area in which the resin is introduced via the introduction channel. During the process of manufacturing the molded part from a composite material, the reinforcing fibers are not disposed in this area, that ensures a homogenous impregnation of the resin within the reinforcing fibers.

The present invention also relates to a process for manufacturing a molded part from a composite material comprising a mixture of reinforcing fibers and a resin implementing a device as described above, which comprises the following steps:

a) disposing reinforcing fibers in the cavity of the device;

b) depositing the counter-mold on the mold;

c) establishing a depression in the cavity with the cavity depressurizing means and establishing a closing vacuum in the closing chamber;

d) introducing resin in the cavity while maintaining the depression in the cavity and the closing vacuum in the closing chamber;

e) stopping the depressurization of the cavity when an excess of resin comes out of the cavity via the channel;

f) thermosetting the resin;

g) detaching the counter-mold from the mold;

h) demolding the molded part;

i) optionally, cutting the molded part obtained at step h).

The closing vacuum is selected in such a manner that the mold and the counter-mold remain in contact during the steps d) to f) of the manufacturing process. This closing vacuum parameterizing will particularly depend on the nature of the device seals, the reinforcing fibers expansion, as well as the closing chamber dimensioning. Of course, the closing vacuum parameterizing is perfectly available to those skilled in the art.

Preferably, a vacuum of at least 300 mbar, preferably of at least 200 mbar, is established in the closing chamber.

Preferably, a depression of at least 800 mbar, preferably of at least 950 mbar, is established in the cavity, with the cavity depressurizing means.

According to one embodiment of the manufacturing process according to the invention, the step c) is carried out by establishing a depression in the cavity with the cavity depressurizing means of at least 800 mbar and a closing vacuum in the closing chamber of at least 300 mbar.

Unlike the infusion technique, the manufacturing process according to the invention does not necessitate tissues or consumables which are onerous and single-use materials. The manufacturing cost of molded parts with the process according to the invention is hence reduced through getting free from these materials and the labor costs inherent to their meticulous manipulation. The manufacturing process according to the invention may be automated.

According to the manufacturing process according to the invention, the resin may be a thermosetting resin. It is advantageously selected from the group consisting of:
unsaturated polyster resins (optionally mixed with loads such as calcium carbonate, so as to improve the aspect of the molded part and to reduce its manufacturing cost);
vinyl ester resins. Advantageously, these vinyl ester resins are implemented with loads, catalysts and set accelerators;
epoxy resins. The polymerized parts obtained from epoxy resins have an excellent fatigue resistance;
phenolic resins;
polyurethanes and polyureas;
polyimides;

According to another embodiment of the manufacturing process, the resin is a thermoplastic resin. It is advantageously selected from the group consisting of polyether ether ketone, polyamides, polyetherimides, polyethylenes, polypropenes, polyphenylene sulfide.

Quite preferably, the resin utilized during the manufacturing process according to the invention is a thermosetting resin.

In embodiments of the manufacturing process, the resin may further comprise loads and/or pigments. In the context of the present invention, it is meant by load, any inert, mineral or vegetal substance which, added to the basic resin, allows modifying its mechanical, electrical or thermal properties, improving the surface aspect, and even reducing the production cost of the molded part.

The selection of the load depends on the desired mechanical properties of the molded part. It may be organic loads such as cellulosic loads, wood flours, kernels and fruits peel flours, plant fibers, starches, or mineral fibers such as carbonates, silicas, talcs, clays and aluminosilicates, or oxides (zinc oxides, magnesium oxides, titanium and antimony oxides, beryllium oxides), aluminas, ceramics, glass powders, hollow glass beads, glass microspheres or carbon black.

The reinforcing fibers are advantageously selected among glass fibers which are obtained from sand (silica) and from additives (alumina, lime carbonate, magnesia, boron oxide). They may also be carbon or aramid fibers.

Preferably, glass fibers are utilized as reinforcing fibers. They may be in the form of mats, preforms or eventually tissues.

According to the invention, the reinforcement volume rate may reach up to about 65%.

Thus, according to this embodiment of the invention and unlike the RTM technique, the manufacturing process has the advantage of not implementing onerous mechanical means such as an autoclave or a press for maintaining the plating of the counter-mold on the mold.

According to an advantageous mode of the manufacturing process, the vacuumization of the closing chamber and the depressurization of the cavity are carried out by means of a same vacuum pump, the cavity depressurizing and the closing chamber vacuumizing circuits being respectively equipped with measuring means (for example pressure gauge) and with regulation means of the pressure and flow rate (for example valve). That has the advantage of being able to separately and appropriately manage, in accordance with the evolution of the manufacturing process, the vacuum called “closing vacuum” and the residual vacuum prevailing in the cavity.

The molded parts according to the manufacturing process of the invention have the following advantageous characteristics which are very similar to those obtained with the infusion technique. They may have:
a large dimension, up to about 10 m;
complex shapes;
low thicknesses, from few tenths of millimeters to several millimeters;

Furthermore, relative to the infusion technique, the molded parts obtained according to the manufacturing process of the present invention have the advantage of having two external faces which are smooth and free of surface defects.

The manufacturing process according to the invention is particularly adapted for the manufacture of cases, boat hulls, bicycle frames, vehicle body elements, tanks, various sanitary articles, or even more generally, any industrial parts with very varied and more or less complex shapes.

The invention will be better understood from the detailed description which is exhibited below with reference to the accompanying drawing representing, by way of non-limiting example, an embodiment of the device for manufacturing a molded part from a composite material according to the invention.

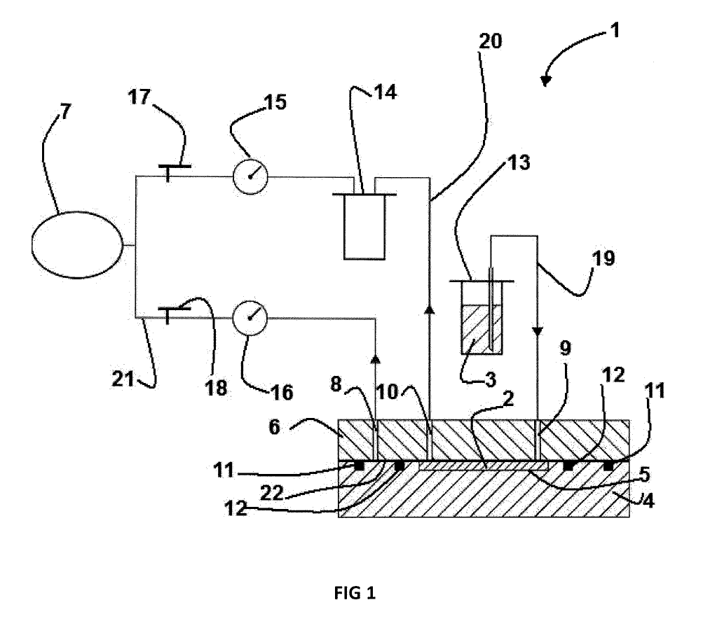

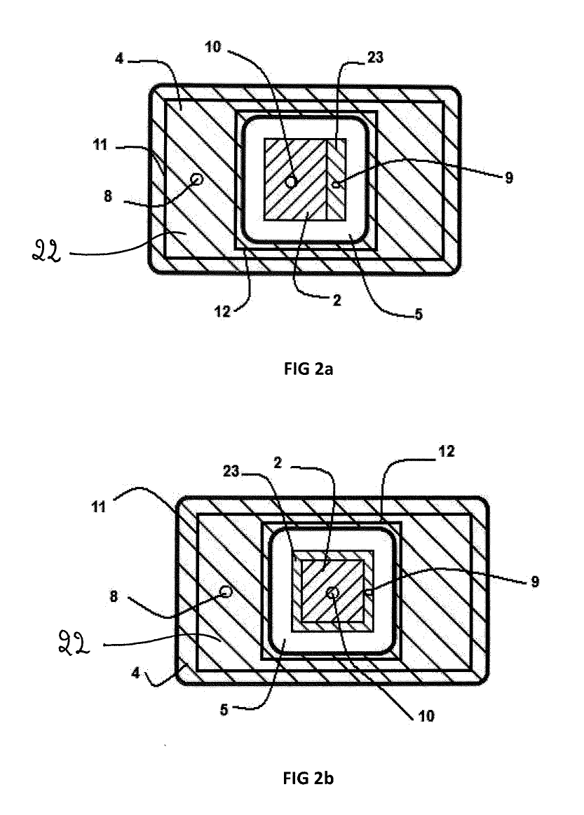

FIG. 1 represents a schematic view of a device for manufacturing a molded part from a composite material according to the invention, in which the portion of the device representing the mold and the counter-mold is viewed in section.
FIG. 2a is a top sectional view of the mold according to a first embodiment of the invention.

FIG. 2b is a top sectional view of the mold according to a second embodiment of the invention.

In FIG. 1, the resin 3 which is a thermosetting resin is stored in a reserve pot 13. The thermosetting resin 3 is conveyed to the introduction channel 9 arranged in the counter-mold 6 via a pipe 19.

A cavity 5 has been arranged in the mold 4. The reinforcing fibers 2 are disposed in the cavity 5.

The mold 4 and the counter-mold 6 include respective support areas which surround the cavity 5. These support areas include two peripheral seals 11, 12 which delimit a closing chamber 22. The seal 12 also has the function of avoiding that the thermosetting resin spreads outside the cavity 5.

The closing chamber 22 is connected to the vacuum pump 7 by means of the pipe 21 and of the channel 8 arranged in the counter-mold 6.

The pipe 21 is equipped with a pressure gauge 16 measuring the closing vacuum and with a valve 18 allowing regulating the pressure and the flow rate.
The counter-mold 6 is equipped with a channel 10 for extracting the thermosetting resin 3. The pipe 20 connects the extraction channel 10 to a seal pot 14 which allows avoiding submerging the vacuum pump 7 with the thermosetting resin 3, when the cavity 5 is depressurized and the thermosetting resin 3 is introduced therein.
The pipe 20 is equipped with a pressure gauge 15 measuring the depression within the cavity 5 and with a valve 17 ensuring the regulation of the pressure and the flow rate. The pipe 20 connects the vacuum pump 7 to the channel 10.

Thus, by appropriately manipulating the valves 18, 17 during the manufacture of the molded part from a composite material, the vacuum may be established in a controlled manner in the cavity 5 and in the closing chamber 22.

FIGS. 2a and 2b show two different embodiments of the area 23 with which is provided the cavity 5. The reinforcing fibers 2 are disposed in the cavity 5 with the exception of the area 23. The thermosetting resin 3 is introduced in the area 3 with the introduction channel 9. These two embodiments allow a homogenous impregnation of all reinforcing fibers 2 due to the controlling of the thermosetting resin 3 flow which migrates over the entire width of the cavity 5 (embodiment represented in FIG. 2a) or over the entire perimeter of the cavity 5 (embodiment represented in FIG. 2b). There is no preferential path of the thermosetting resin 3.

1. A device for manufacturing a molded part from a composite material comprising a mixture of reinforcing fibers and a resin, said device comprising:
one mound in which a cavity configured for the disposition of reinforcing fibers is arranged;
one counter-mound which, intended to press against the mound to close the cavity, is equipped with at least one channel for introducing the resin in the cavity, the introduction channel being adapted to be connected to at least one resin supply source;
means for positioning and fixing the counter-mound on the mound;
at least one means for depressurizing the cavity to ensure the introduction of the resin therein and at least one channel for extracting the resin in excess out of the cavity,
wherein the mound and the counter-mound include respective support areas surrounding the cavity, these support areas comprising two peripheral seals offset with respect to each other, from the inside to the outside, delimiting a closing chamber which is connected to a vacuum source, said vacuum source depressurizing the closing chamber to ensure the plating of the counter-mound on the mound.

2. The device according to claim 1, wherein the cavity depressurizing means comprises a vacuum pump, a channel arranged in the counter-mound or in the mound used for depressurizing the cavity and extracting the resin in excess out of the cavity, and a depressurizing circuit in the form of a pipe which connects the vacuum pump to the channel.

3. The device according to claim 2, wherein the pipe connecting the channel arranged in the counter-mound or in the mound to the vacuum pump is equipped with a seal pot intended to collect the resin extracted from the cavity.

4. The device according to claim 1, wherein the introduction channel and the extraction channel have a truncated cone shape.

5. The device according to claim 1, wherein the closing chamber is connected to the vacuum source by means of a vacuumizing circuit in the form of a pipe and a channel arranged in the counter-mound or in the mound.

6. The device according to claim 5, wherein the cavity depressurizing circuit and the closing chamber vacuumizing circuit are disposed in parallel and converge upstream of the same vacuum pump.

7. The device according to claim 6, wherein the cavity depressurizing circuit and the closing chamber vacuumizing circuit are equipped with means for measuring and means for regulating the pressure and the flow rate.

8. The device according to claim 1, wherein it further comprises at least one means for centering the counter-mound on the mound.

9. A process for manufacturing a molded part from a composite material comprising a mixture of reinforcing fibers and a resin implementing the device according to claim 1 which comprises the following steps:
a) disposing reinforcing fibers in the cavity of the device;
b) depositing the counter mound on the mound;
c) establishing a depression in the cavity with the cavity depressurizing means and establishing a closing vacuum in the closing chamber;
d) introducing resin in the cavity while maintaining the depression in the cavity and the closing vacuum in the closing chamber;
e) stopping the depressurization of the cavity when an excess of resin comes out of the cavity via the channel;
thermosetting the resin;
g) detaching the counter-mound from the mound;
h) demoulding the molded part;
i) optionally, cutting the molded part obtained at step h).

10. The manufacturing process according to claim 9, wherein the step c) is carried out by establishing a depression in the cavity with the cavity depressurizing means of at least 800 mbar and a closing vacuum in the closing chamber of at least 300 mbar.
